(19) United States
(12) Patent Application Publication
(10) Pub. No.: US 2011/0181578 A1
(43) Pub. Date: Jul. 28, 2011

(54) IMAGE DISPLAY APPARATUS

(75) Inventors: Koichi Ohta, Kawasaki-shi (JP); Hiroshi Saito, Atsugi-shi (JP)

(73) Assignee: CANON KABUSHIKI KAISHA, TOKYO (JP)

(21) Appl. No.: 13/005,830

(22) Filed: Jan. 13, 2011

(30) Foreign Application Priority Data
Jan. 27, 2010 (JP) 2010-015534

(51) Int. Cl. G06F 3/038

(52) U.S. Cl. 345/211

(57) ABSTRACT

An image display apparatus has a driver circuit which generates drive voltage for driving a display panel; and a drive power supply circuit which supplies power supply voltage and reference voltage for specifying a value of the drive voltage to the driver circuit. The drive power supply circuit comprises a reference voltage conversion unit which changes the reference voltage value according to a control voltage value; and a power supply voltage conversion unit which changes the power supply voltage value according to the control voltage value, or the reference voltage value output from the reference voltage conversion unit, so that both the power supply voltage and the reference voltage decrease or increase.

### BACKGROUND OF THE INVENTION

1. Field of the Invention

The present invention relates to an image display apparatus, and more particularly to a power supply circuit for a drive circuit of an image display apparatus.

2. Description of the Related Art

As a flat type image display apparatus, a display apparatus (electron beam display apparatus) using electron-emitting devices, liquid crystal display apparatuses, plasma display apparatuses and organic EL display apparatuses, for example, are known. This type of flat image display apparatus has a display panel (matrix panel) on which many display elements are arrayed in a matrix, and a driver circuit (driver IC) for driving the display elements. A modulation signal, which was modulated according to the image signal, is input to a drive target display element. For the modulation method, pulse width modulation (PWM), and pulse height modulation (PHM), which is also called “pulse amplitude modulation (PAM)”, for example, are known. Recently slimmer construction and lower power consumption are desired for image display apparatuses, and efficient power conversion and a drive method are demanded.

Japanese Patent Application Laid-Open No. 2000-310971 discloses means for controlling drive voltage and displaying an image with the hue desired by a user by driving pulse width modulation signals at voltages of respective power supplies, which differ from each other for each luminous body color, and changing the respective output voltage of the power supplies.

### SUMMARY OF THE INVENTION

A standard drive circuit has a buffer amplifier in the output stage. By supplying the power supply voltage, as well as supplying a reference voltage to determine the output value of the drive voltage, to the buffer amplifier, stable drive voltage output is implemented. Controlling the drive voltage of the display elements in the image display apparatus is effective for adjusting hue and controlling power based on ABL control. In order to control the drive voltage, it is necessary to variably control the reference voltage to be supplied to the buffer amplifier. Conventionally the power supply voltage is input as a fixed value, even if the reference voltage is changed for controlling the drive voltage. With this configuration, however, the difference between the power supply voltage and the reference voltage increases as the setting value of the reference voltage decreases, and the circuit loss of the buffer amplifier unit increases in some cases. FIG. 2A show the fluctuation of the relationship of the power supply voltage and the reference voltage, FIG. 2B shows the fluctuation of a power supply current, and FIG. 2C shows the fluctuation of a loss generated in the buffer amplifier, when the drive voltage setting value is changed. The circuit loss consumes not only unnecessary power, but generates heat in the driver circuit, so it is desirable to minimize this.

It is an object of the present invention to prevent an increase in circuit loss in the driver circuit, which is generated when the drive voltage is changed.

The present invention provides an image display apparatus, including: a display panel; a driver circuit which generates drive voltage for driving the display panel, and outputs the drive voltage to the display panel; and a drive power supply circuit which supplies power supply voltage and reference voltage for specifying a value of the drive voltage to the driver circuit, wherein the drive power supply circuit includes: a reference voltage conversion unit which changes a value of the reference voltage to be output according to a value of control voltage to be input; and a power supply voltage conversion unit which changes a value of the power supply voltage to be output according to the value of the control voltage, or the value of the reference voltage to be output from the reference voltage conversion unit, so that both the power supply voltage and the reference voltage decrease or increase.

According to the present invention, an increase in circuit loss in the driver circuit, which is generated when the drive voltage is changed, can be prevented. Another effect is that heating in the driver circuit can be suppressed, and the radiation design in the image display apparatus as s whole can be simplified.

Further features of the present invention will become apparent from the following description of exemplary embodiments with reference to the attached drawings.

### BRIEF DESCRIPTION OF THE DRAWINGS

FIG. 1A is a graph depicting the power supply voltage and reference voltage, FIG. 1B is a graph depicting power supply current, and FIG. 1C is a graph depicting circuit loss of a driver circuit, with respect to a column wiring voltage setting value of the present invention used for Example 1;

FIG. 2A is a graph depicting the power supply voltage and reference voltage, FIG. 2B is a graph depicting the power supply current, and FIG. 2C is a graphy depicting circuit loss of a driver circuit, with respect to the normal column wiring voltage setting value used for Example 1;

FIG. 3 shows an example of a general configuration of an image display apparatus used for an embodiment of the invention;

FIG. 4A and FIG. 4B show examples of an internal configuration of a row driver circuit used for Example 1;

FIG. 5A shows an example of an internal configuration of a column driver circuit used for Example 1, and FIG. 5B shows an operation of the reference waveform generation unit;

FIG. 6A and FIG. 6B are diagrams depicting the drive voltage and power supply current in PWM for the gradation data used for Example 1, and FIG. 6C and FIG. 6D are diagrams depicting the drive power voltage and power supply current in PHM;

FIG. 7A to FIG. 7C show a configuration of the output amplifier of the driver circuit;

FIG. 8A is a wiring diagram inside the drive power supply circuit of Example 1, and FIG. 8B and FIG. 8C are wiring diagrams inside the drive supply circuit of Example 2;

FIG. 9 shows an example of an internal configuration of the power supply voltage conversion unit inside the drive power supply circuit used for Example 1;

FIG. 10 shows an example of an internal configuration of the reference voltage conversion unit inside the drive power supply circuit used for Example 1; and

FIG. 11 is an example of a configuration of the display panel unit of the image display apparatus used for Example 1.

### DESCRIPTION OF THE EMBODIMENTS

Now embodiments of the present invention will be described in detail with reference to the drawings.

The present invention relates to an image display apparatus having a display panel with a simple matrix structure (matrix panel) where a plurality of display elements are connected by a plurality of column wirings and a plurality of row wirings. More specifically, the present invention relates to a drive power supply circuit which supplies the power supply voltage and reference voltage to a driver circuit (driver IC) which applies drive voltage to this type of display panel. Image display apparatuses include: an electron beam display apparatus, a plasma display apparatus, an organic EL display apparatus and a liquid crystal display apparatus, for example. Especially a simple matrix type image display apparatus, of which wiring capacity and parasitic capacity of display elements are large, and current that flows through the driver circuit concentrate on selected lines, is a preferred mode to apply the present invention. The electron beam display apparatus refers to a display which displays images by the emission of phosphors using electrons emitted from a cold cathode type electron-emitting devices. For the cold cathode type electron-emitting device, an FE (field emission) electron-emitting device, an MIM (Metal/Insulator/Metal) electron-emitting device, and a surface conduction electron-emitting device, for example, are used.

### Example 1

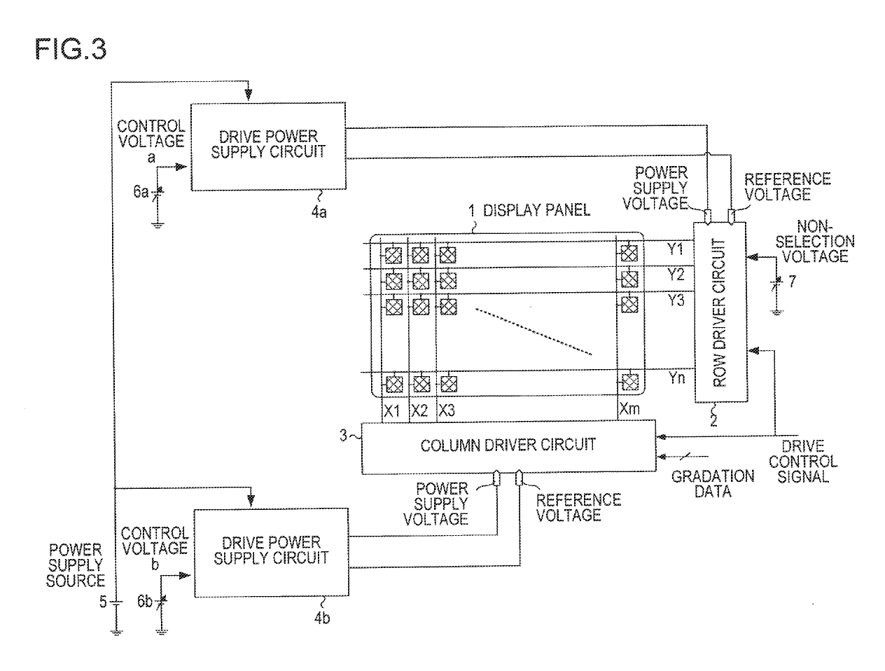

An embodiment of the present invention will now be described in concrete terms with reference to FIG. 3. FIG. 3 is a diagram depicting an example of a general configuration of an image display apparatus. In FIG. 3, 1 is a display panel, 2 is a row driver circuit which sequentially scans the row wirings, and outputs the selection voltage and non-selection voltage, and 3 is a column driver circuit which outputs the drive voltage to the column wirings. 4a is a drive power supply circuit which outputs power supply voltage and reference voltage for the row driver circuit 2, 4b is a drive power supply circuit which outputs the power supply voltage and reference voltage to the column driver circuit 3, and 5 is a power supply source which supplies power to the drive power supply circuit. 6a is a control voltage for controlling the output voltage of the drive power supply circuit 4a, 6b is a control voltage for controlling the output voltage of the drive power supply circuit 4b, and 7 is a non-selection voltage which becomes the source of voltage which the row driver circuit outputs to the non-selected row wirings.

In FIG. 3, the display panel 1 is a matrix panel in which the luminous brightness changes according to the amplitudes of the drive voltage (modulation signal) and selection voltage (scanning signal) to be applied, so that the images having hues desired by the user can be displayed. The display panel 1 is connected to the row driver circuit 2 and column driver circuit 3, and images are formed by the drive voltage to be output from these driver circuits and pulse shapes of the selection voltage and non-selection voltage. The drive voltage and selection voltage which are output by these driver circuits are set based on the voltage values of the reference voltage which are output from the drive power supply circuits 4a and 4b, and stable output is obtained by a buffer amplifier in the driver circuit. In the example shown in FIG. 3, there are one power supply source 5 and two control voltages 6, and the power supply voltage and reference voltage are output to the row driver circuit 2 and column driver circuit 3 respectively.

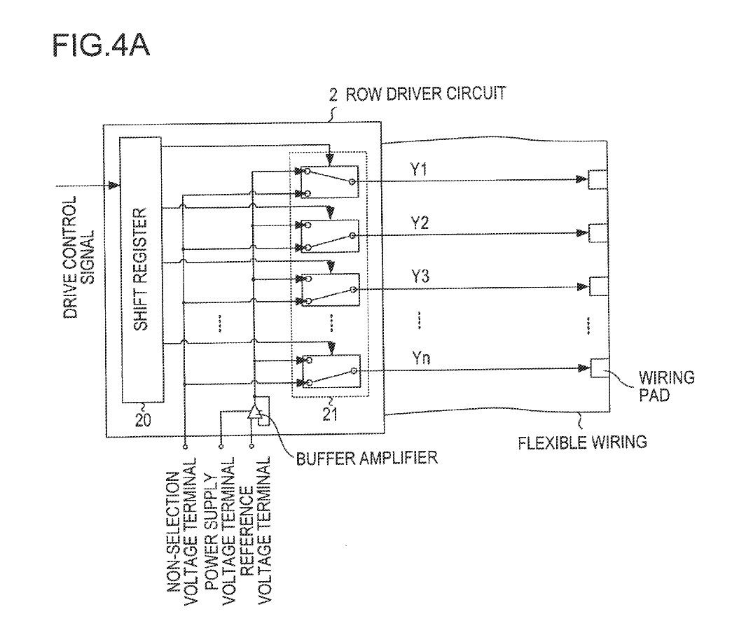

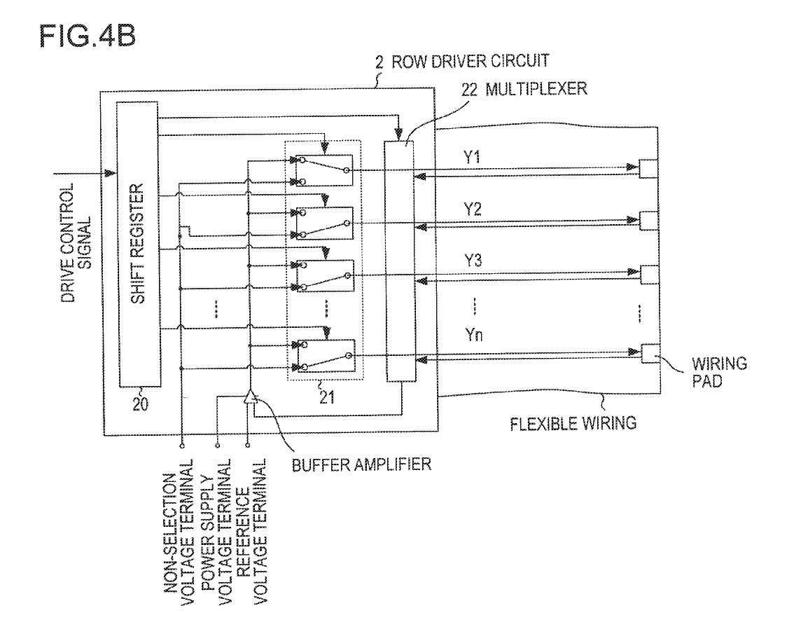

This configuration example of the row driver circuit 2 will be described in concrete terms with reference to FIG. 4A and FIG. 4B. Inputs of the row driver circuit 2 are at least the power supply voltage, reference-voltage, non-selection voltage 7 and drive control signals, which are output from the drive power supply circuit 4a. Based on the drive control signal, the row driver circuit 2 applies the selection voltage to the drive target (selection target) row wirings, and the non-selection voltage 7 to the unselected row wirings, by the shift register 20 and selection switch 21. The row driver circuit 2 and row wirings are connected via flexible wirings or the like. The buffer amplifier is a circuit to output stable selection voltage based on the voltage value of the reference voltage, using the power supply voltage from the drive power supply circuit 4a as a power source. The shift register 20 is a circuit for switching the selection switch 21 (or selection switch 21 and the multiplexer 22) based on the drive control signal. The voltage based on the voltage value of the reference voltage and non-selection voltage 7 are input to the selection switch 21, and output is switched between the selected row wirings and the non-selected row wirings by the control signal from the shift register 20. The non-selection voltage 7 here is an arbitrary voltage or GND, and is preferably a variable voltage.

FIG. 4A is a configuration example of a normally used row driver circuit 2, and FIG. 4B is a configuration example of a row driver circuit 2, which is used when the ON resistance of MOSFET or a voltage drop in flexible wirings is large. FIG. 4A is a configuration to feedback the voltage directly under the output of the buffer amplifier. FIG. 4B is a configuration to select the selection voltage, which was fed back from the wiring pad at the tip of the flexible wiring based on control of the shift register 20, feeding it back by the multiplexer 22. According to the configuration in FIG. 4B, the resistance from the output of the buffer amplifier, which outputs the selection voltage, to the wiring pad, can be corrected, therefore the output accuracy of the selection voltage to be applied to the wiring pad improves.

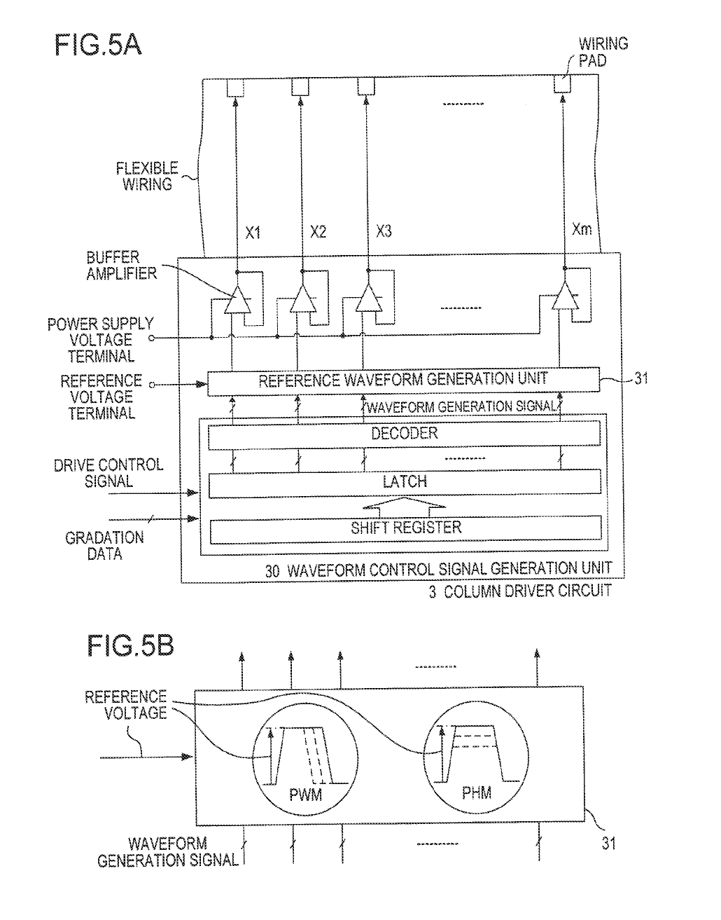

Now a configuration example of the column driver circuit 3 will be described in concrete terms with reference to FIG. 5A. Inputs of the column driver circuit 3 are at least the power supply voltage, reference voltage, gradation data and drive control signals, which are output from the drive power supply circuit 4b. The column driver circuit 3 applies the column wiring drive waveforms (X1 to Xm) to each column wiring via a flexible wiring. A waveform control signal generation unit 30 performs serial/parallel conversion based on gradation data and drive control signals using a shift register and latch, and a decoder generates waveform generation signals. The generated waveform generation signals are input to a reference waveform generation unit 31 along with the reference voltage. The reference waveform generation unit 31 performs a level shift from a waveform generation signal, as shown in FIG. 5B, and generates a column wiring drive waveform having a pulse height value based on the reference voltage in the case of pulse width modulation (PWM). In the case of pulse height modulation (PHM), on the other hand, digital/analog conversion is performed for gradation data using the pulse height value based on the reference data as the pulse height data in the maximum gradation data, so as to generate the column wiring drive waveform of the image display apparatus. The output of the generated column wiring drive waveform is fed back via the buffer amplifiers (321 to 32m), to which the power supply voltage, output from the drive power supply circuit 4, is supplied, and is stabilized. The stabilized output is applied to the display elements of the display panel 1 as the column wiring drive voltage waveforms (X1 to Xm) via the flexible wirings.

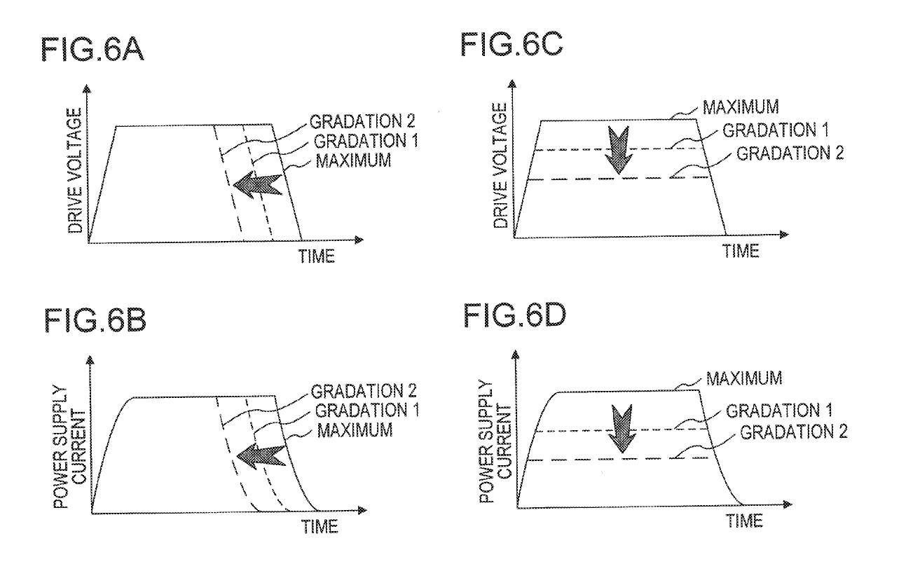

FIG. 6A to FIG. 6D show examples of the column wiring drive voltage waveforms based on the gradation data upon pulse width modulation (PWM) driving, and pulse height modulation (PHM) driving and the power supply current waveforms of the column driver circuit. FIG. 6A shows a drive voltage in PWM driving and FIG. 6B shows a power supply current in PWM driving. FIG. 6C shows a drive voltage in PHM driving, and FIG. 6D shows a waveform of a power supply current in PHM driving.

In the case of PWM driving, if the gradation drops from maximum gradation to gradation 1 and to gradation 2, as shown in FIG. 6A, the drive period decreases as shown in FIG. 6B, although the power supply current is the same value as when gradation is the maximum. Whereas in the case of PHM driving, if gradation drops from maximum gradation to gradation 1 and to gradation 2, as shown in FIG. 6C, the power supply current drops as the drive voltage drops as shown in FIG. 6D, although the drive period is the same. This power supply current, which flows into the buffer amplifier of the driver circuit during the drive period, generates loss. In other words, this loss is generated in both driver circuits of PWM driving and PHM driving. The later mentioned drive power supply circuit of the present embodiment can be used for both PWM driving and PHM driving. The output of the column driver circuit was described in FIG. 6A to FIG. 6D, but the drive power supply circuit of the present embodiment may be applied to the row driver circuit as well, since a similar loss is also generated in the row driver circuit.

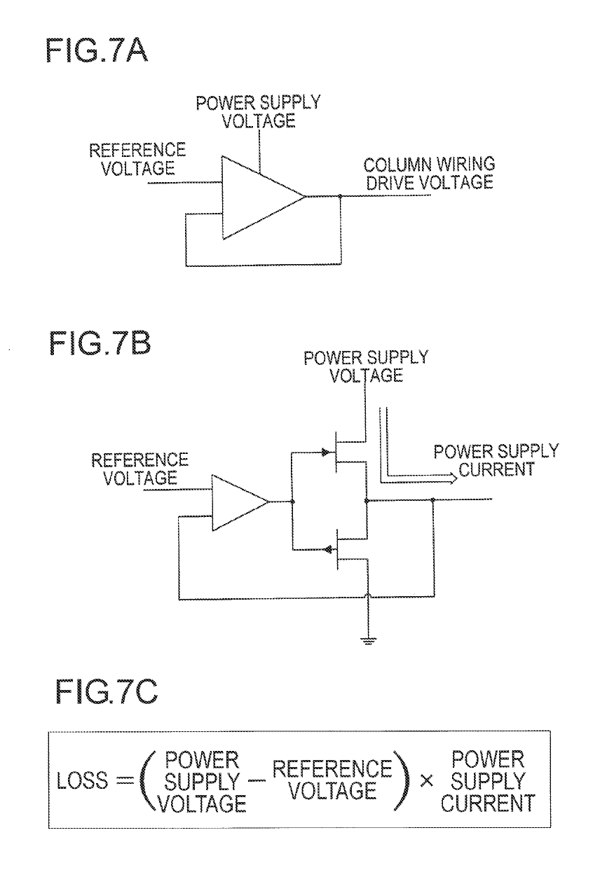

FIG. 7 are diagrams depicting the loss of the buffer amplifier of the column driver circuit in the case of PWM driving shown in FIG. 6A and FIG. 6B. FIG. 7A shows the wiring structure of the buffer amplifier of the column driver circuit, FIG. 7B shows the internal structure of FIG. 7A specifically, and FIG. 7C shows a calculation formula of the loss of the buffer amplifier. As mentioned above, a buffer amplifier as shown in FIG. 7A is normally used for a driver circuit which requires a large transient drive current, such as the case of a simple matrix image display apparatus in order to stabilize the output voltage. This buffer amplifier is a circuit for outputting stable drive voltage and power supply current by controlling the switching of a semiconductor switch, which is connected to the power supply voltage via a comparator so as to be equal to the voltage value of the reference voltage (reference waveform voltage), as shown in FIG. 7B. As FIG. 7B shows, voltage difference between the power supply voltage and drive voltage is generated on both ends of the semiconductor switch, where power supply current flows and circuit loss is generated. The pulse height value of the drive voltage is determined by the reference voltage. Since the loss generated in the buffer amplifier is dominant in the period where this pulse height value is applied, the circuit loss generated in the buffer amplifier of the column driver circuit is determined by the calculation formula shown in FIG. 7C.

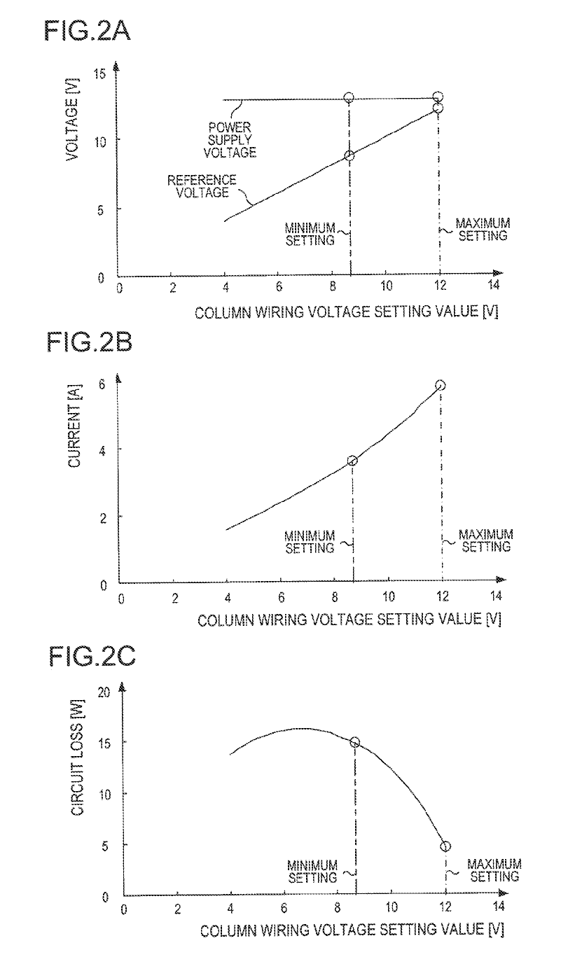

Now the dependency of loss on the drive voltage setting value will be described with reference to FIG. 2A to FIG. 2C. FIG. 2A to FIG. 2C are all graphs showing the total loss generated in all the output channels of each buffer amplifier. FIG. 2A shows a relationship of the power supply voltage and the reference voltage, FIG. 2B shows the total of the power supply current, and FIG. 2C shows the loss generated in the buffer amplifier, which fluctuates when changing the drive voltage setting value. As FIG. 7C shows, in the buffer amplifier in a driver circuit, the voltage difference between the power supply voltage and the reference voltage is a factor which determines the loss value. Therefore as disclosed in Japanese Patent Application Laid-Open No. 2000-310971, the loss as shown in FIG. 2C is generated in the image display apparatus which displays images with a hue which the user desires by changing the drive voltage setting value. In other words, if the reference voltage is changed from the maximum setting to the minimum setting in order to change the drive voltage setting value, the voltage difference from the power supply voltage increases as shown in FIG. 2A. As a result, loss increases as shown in FIG. 2C, even though the drive voltage dropped and the power supply current deceased, as shown in FIG. 2B. The loss in the case of PHM driving can be considered in the same manner.

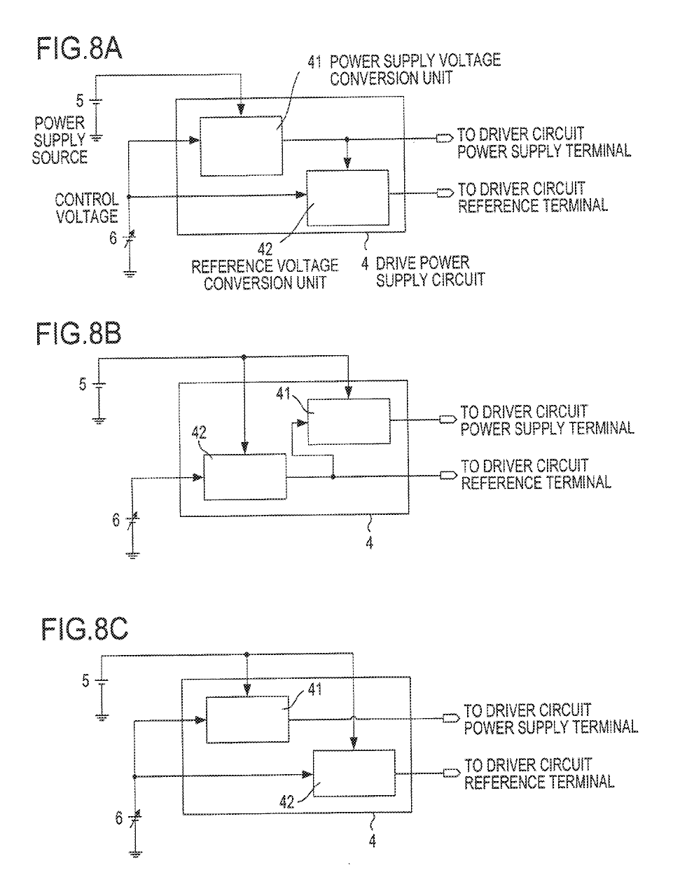

FIG. 8A is a diagram depicting an example of the drive power supply circuit 4 for suppressing the loss upon changing the drive voltage setting value. The power supply source 5, which is constituted by an AC/DC converter, for example, is a supply source for supplying the drive power from outside the drive power supply. The control voltage 6 is an indication value which the user can set arbitrarily by a variable resistor and microcomputer. The drive power supply circuit 4, of which inputs are power from the power supply source 5 and the control voltage 6, is a circuit to perform voltage conversion in the power supply voltage conversion unit 41 and the reference voltage conversion unit 42 respectively, based on the value of the control voltage 6. Here both the power supply voltage and the reference voltage are controlled to decrease or increase, and are supplied to the driver circuit.

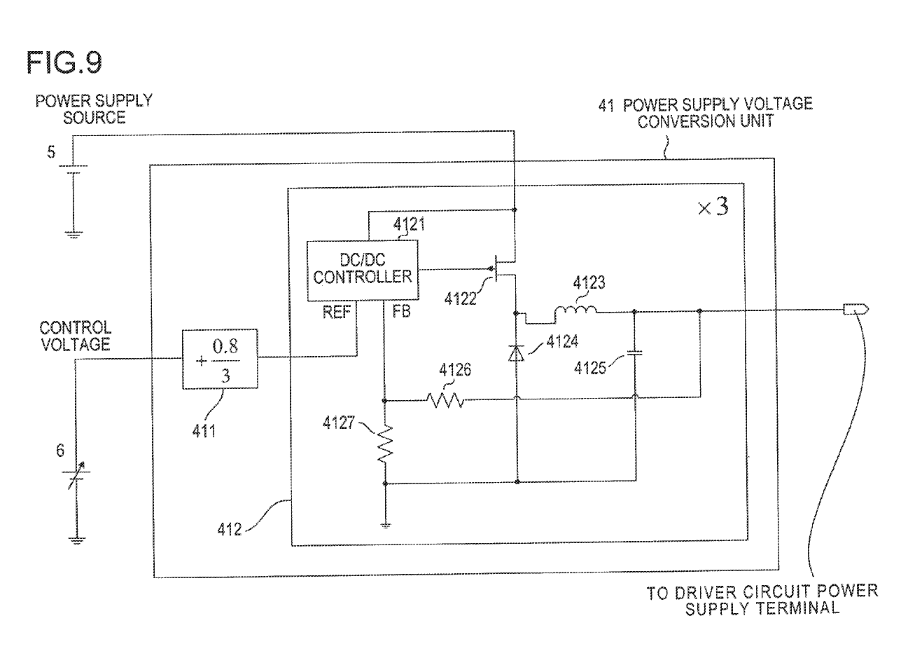

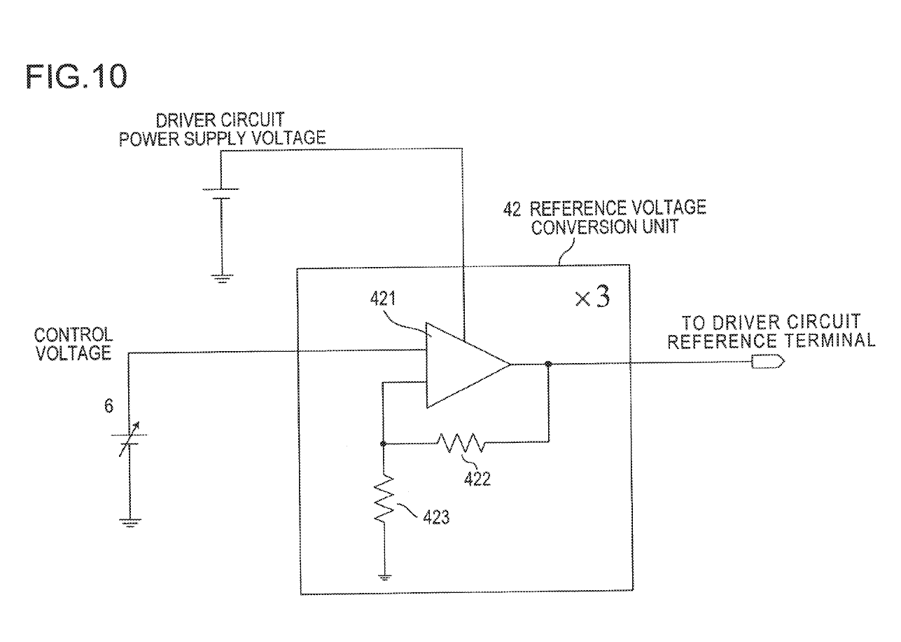

FIG. 9 and FIG. 10 show the configurations of the power supply voltage conversion unit 41 and the reference voltage conversion unit 42. This is an example of a circuit in which the reference voltage output is three times the indication value of the control voltage 6, and the power supply voltage output is three times +0.8V.

As FIG. 9 shows, the power supply voltage conversions unit 41 is constituted by a standard chopper type step-down switching converter 412. In this system, output voltage is fed back and compared with the reference voltage, whereby the ON period of the switching transistor 4122 is controlled using a DC/DC controller 4121, so as to step down the voltage by the energy charged in a coil 4123. The multiplying factor of the output voltage with respect to the reference voltage is determined by the voltage dividing ratio based on the feedback resistors 4126 and 4127 for the voltage to be fed back. Here output of the switching converter 412 can be variable-controlled by inputting the control voltage 6 as the reference voltage. For example, if the reference voltage is the control voltage 6 to which 0.8/3 V is added by an adder 411, then the relationship of the power supply voltage and the reference voltage can be maintained constant with a 0.8 V difference. The adder 411 can be a standard analog addition circuit which is constituted by a resistor and operational amplifier. The same effect can also be obtained by setting the reference voltage as a fixed value, and making the supply destination of the control voltage 6 to be parallel with the feedback resistors 4126 and 4127, and adjusting the resistance values. The above explanation is a case of a standard chopper type step-down switching converter 412, but the same effect can also be obtained with a boosting type, inverting type, insulation type and synchronous rectification type.

On the other hand, as FIG. 10 shows, the reference voltage conversion unit 42 can be constituted by a non-inverting amplifier circuit of which power supply is output of the power supply voltage conversion unit 41, and reference voltage is the control voltage 6. However the configuration is not limited to this, but a similar effect can be obtained even if a differential amplifier circuit, switching converter and linear regular are used. If the power supply voltage conversion unit 41 is constituted by an inverting type switching converter, however, the non-inverting amplifier circuit of the reference voltage conversion unit 42 must be replaced with an inverting amplifier circuit.

In the case of the power supply voltage conversion unit 41 shown in FIG. 9, the power supply voltage and the reference voltage are controlled so that the difference of these voltages is constant, but the configuration of the present invention is not limited to this. If the voltage difference between the reference voltage and the power supply voltage can be suppressed from becoming too large, by decreasing (or increasing) the value (absolute value) of the power supply voltage as the value (absolute value) of the reference voltage decreases (or increases), then an increase in circuit loss can be suppressed. The relationship of the reference voltage and the power supply voltage need not be linear, and the power supply voltage may be changed in stages or discontinuously.

For example, if, in the power supply voltage conversion unit 41 shown in FIG. 9, the magnifying factor of the switching converter 412 is changed from the magnifying factor of the reference voltage conversion unit 42 (e.g. set to X4) by adjusting the feedback resistance, then the relationship between the power supply voltage and the reference voltage can be a ratio relationship (4/3 times). In this case, an even more complicated potential relationship can be controlled if an adder 411 is combined. The application of a ratio relationship can be effective according to the capability of the buffer amplifier of the driver circuit. In other words, the added voltage amount (ΔV) to the output voltage required for the power supply voltage of the buffer amplifier may change according to the power supply current. Therefore in the case of a buffer amplifier in which ΔV can be small, if the drive voltage setting value is low, ≢V can be small, so a further loss suppression effect can be implemented if this configuration is used.

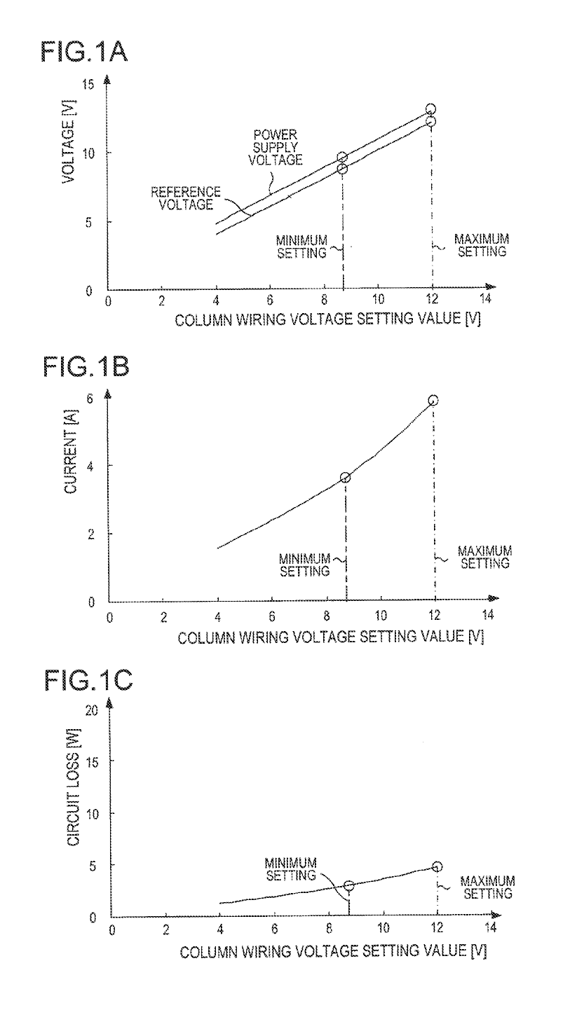

The effect of this configuration will now be described with reference to FIG. 1A to FIG. 1C. FIG. 1A to FIG. 1C are graphs totaling the loss generated in each buffer amplifier for all the output channels. FIG. 1A shows the fluctuation of a relationship of the power supply voltage and the reference voltage, FIG. 1B shows the fluctuation of a total power supply current, and FIG. 1C shows the fluctuation of a loss generated in the buffer amplifier, when the drive voltage setting value is changed. As FIG. 1A shows, by changing the power supply voltage following up the reference voltage, the voltage difference does not change even if the setting is changed from maximum to minimum, and as a result, the circuit loss of the driver circuit is suppressed to be like FIG. 1C.

For an example, the effect will be described for a driver circuit in which the power supply voltage is 12.8 V, the reference voltage is 12.0 V and the power supply current is 5.7 A when maximum column wiring voltage is set, and the reference voltage is 8.5 V and the power supply current is 4.4 A when minimum column wiring voltage is set. In a conventional configuration, the power supply voltage is fixed to 12.8 V, but in this configuration, the power supply voltage is controlled to be a reference voltage +0.8 V, as shown in FIG. 1A. As a result of calculating loss by substituting these values in the expression in FIG. 7C, the loss of maximum column wiring voltage setting is 4.56 W. In the same manner, the loss of minimum column wiring voltage setting is 18.92 W in a conventional configuration, while it is 3.52 W in the present configuration. In other words, according to the present example, 15.4 W of loss can be improved.

In the drive power supply circuit constructed as in FIG. 8A, the output of the power supply voltage conversion unit 41 is used as the power supply of the reference voltage conversion unit 42, so the relationship of “power supply voltage reference voltage” can be maintained even during the rise time immediately after power ON, or during an abnormality. Therefore an additional circuit to prevent inversion of the power supply voltage and reference voltage during rise time can be omitted.

Furthermore, negative power supply can be provided by the power supply voltage conversion unit 41 which includes a switching converter. According to this configuration, negative reference voltage can be generated for the reference voltage conversion unit 42 without providing a separate negative power supply, even if the power supply source 5 is outputting positive voltage, therefore the configuration of the power supply unit of the image display apparatus can be simplified.

For the power supply of the reference voltage conversion unit 42, a power of which difference from the output of the reference voltage conversion unit 42 is decreased is supplied by performing voltage conversion once by the switching converter 412. Thereby the loss generated during converting power by the reference voltage conversion unit 42 can be suppressed compared with the case of directly supplying power from the power supply source 5.

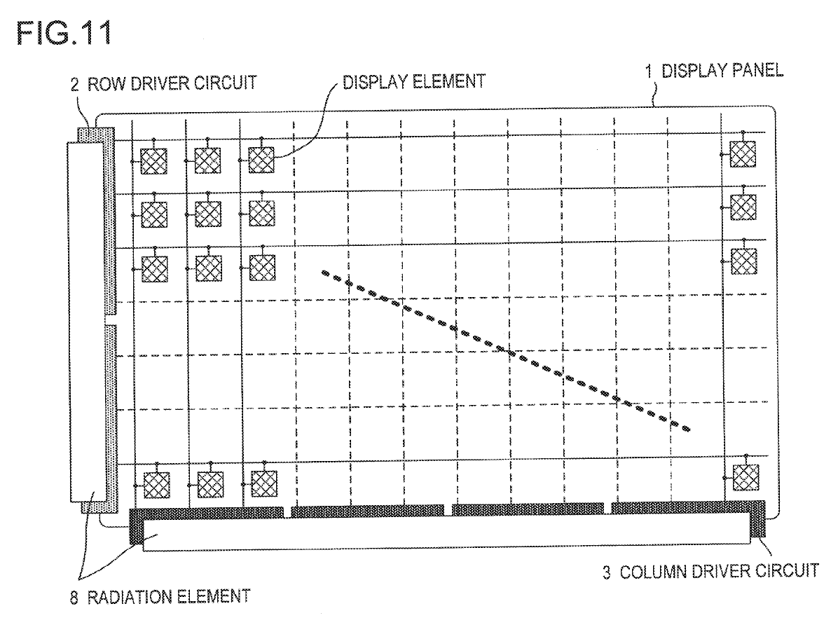

FIG. 11 is a diagram depicting a radiation design of the display panel unit in the image display apparatus. 1 is a display panel, 2 is a row driver circuit, 3 is a column driver circuit, and 8 is a radiation element. In the configuration of this example, two row driver circuits 2 are disposed at the left, and four column driver circuits 3 are disposed at the bottom. As FIG. 11 shows, the row driver circuit 2 and the column driver circuit 3 are normally disposed at the edge of the display panel 1. The radiation element 8 is installed in order to radiate the heat generated in each driver circuit. One radiation element 8 may be installed for each driver circuit or may be installed for each board. In the case of the structure where each driver circuit and radiation element 8 are disposed in the edge like this, a more thick image display apparatus or more area of the frame is required as the loss generated in each drive circuit is greater, in order to secure the radiation capability of the radiation element 8. Conventionally, a fixed power supply voltage is supplied to the driver circuit, and if the drive voltage is changed, a great loss is generated in the driver circuit. According to this example, the loss conventionally generated in the driver circuit is shifted to the power supply conversion circuit unit 41, and a switching converter configuration is used, whereby the total of the loss can be suppressed. According to this configuration, the power supply voltage conversion unit 41 can be disposed in a space where a sufficient radiation structure can be secured, and the radiation design around the driver circuit can be simplified. As a result, a slim and narrow framed image display apparatus can be easily implemented. Furthermore, by constructing a high efficiency switching converter, a decrease in thickness and frame width of the image display apparatus are not interrupted, even if the power supply voltage conversion unit 41 is disposed near the driver circuit. If this configuration is used, loss due to a drop in voltage when the power supply voltage is supplied from the power supply voltage conversion unit 41 to the driver circuit, can be suppressed, and loss can be further controlled.

### Example 2

This is an example of the connection inside the drive power supply circuit 4 shown in FIG. 8B. In this configuration, both the power supply voltage conversion unit 41 and the reference voltage conversion unit 42 receive power from the power supply source 5. The reference voltage conversion unit 42 is input to the power supply voltage conversion unit 41 as the control voltage. In the drive power supply circuit 4 constructed like this, in addition to the effect of suppressing circuit loss in the drive circuit and simplifying the radiation element described in Example 1, the following effect is obtained in the case when the voltage difference, between the power supply voltage and the reference voltage, is specified. For example, in the case of the drive circuit to which supply of power supply voltage is prohibited before determining the reference voltage, the output of the power supply voltage conversion unit 41 is applied at startup before the output of the reference voltage conversion unit 42 is determined if the configuration in FIG. 8A is used. Therefore in the case of the configuration in FIG. 8A, it is preferable to install an additional circuit so that the power supply voltage is not output until the reference voltage is determined. Whereas in the case of the configuration in FIG. 8B, the power supply voltage is not output before the reference voltage is determined, so the above mentioned additional circuit can be omitted, and accurate sequence control is enabled without making the circuit configuration complicated.

The configuration in which control voltage 6 is input to the power supply voltage conversion unit 41, as shown in FIG. 8C, can also be used. In this case, an effect similar to, that of the configuration in FIG. 8B can be obtained by setting the rise time constant of the power supply voltage conversion unit 41 to be longer than that of the reference voltage conversion unit 42.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-015534, filed on Jan. 27, 2010, which is hereby incorporated by reference herein in its entirety.

What is claimed is:

1. An image display apparatus, comprising:
a display panel;
a driver circuit which generates drive voltage for driving the display panel, and outputs the drive voltage to the display panel; and
a drive power supply circuit which supplies power supply voltage and reference voltage for specifying a value of the drive voltage to the driver circuit, wherein
the drive power supply circuit comprises:
a reference voltage conversion unit which changes a value of the reference voltage to be output according to a value of control voltage to be input; and
a power supply voltage conversion unit which changes a value of the power supply voltage to be output according to the value of the control voltage, or the value of the reference voltage to be output from the reference voltage conversion unit, so that both the power supply voltage and the reference voltage decrease or increase.

2. The image display apparatus according to claim 1, wherein
the power supply voltage conversion unit controls the value of the power supply voltage to be output so that a difference between the power supply voltage and the reference voltage becomes constant.

3. The image display apparatus according to claim 1, wherein
the power supply voltage conversion unit controls the value of the power supply voltage to be output so that a ratio of the power supply voltage and the reference voltage becomes constant.

4. The image display apparatus according to claim 1, further comprising a power supply source which supplies power to the drive power supply circuit, wherein
the power supply source supplies power to the power supply voltage conversion unit,
the reference voltage conversion unit uses the output of the power supply voltage conversion unit as power source, and
the control voltage is input to both the power supply voltage conversion unit and the reference voltage conversion unit.

5. The image display apparatus according to claim 1, further comprising a power supply source which supplies power to the drive power supply circuit, wherein
the power supply source supplies power to both the power supply voltage conversion unit and the reference voltage conversion unit,
the control voltage is input only to the reference voltage conversion unit, and
the power supply voltage conversion unit uses the reference voltage to be output from the reference voltage conversion unit as input, and controls the value of the power supply voltage based on the reference voltage value.

6. The image display apparatus according to claim 1, further comprising a power supply source which supplies power to the drive power supply circuit, wherein
the power supply source supplies power to both the power supply voltage conversion unit and the reference voltage conversion unit,
the control voltage is input to both the power supply voltage conversion unit and the reference voltage conversion unit, and
a rise time constant of the power supply voltage conversion unit is longer than that of the reference voltage conversion unit.

7. The image display apparatus according to claim 1, wherein
the power supply voltage conversion unit includes a switching converter, and the reference voltage conversion unit is constituted by a non-inverting amplifier circuit.

8. The image display apparatus, according to claim 1, wherein
the power supply voltage conversion unit includes an inverting type switching converter, and the reference voltage conversion unit is constituted by an inverting amplifier circuit.

9. The image display apparatus according to claim 1, wherein
the display panel is a display panel having a structure in which a plurality of display elements are connected in a matrix by a plurality of column wirings and a plurality of row wirings.

10. The image display apparatus according to claim 9, wherein
the display element is a cold cathode type electron-emitting device.
